(19) United States
(12) Patent Application Publication
(10) Pub. No.: US 2009/0070904 A1
(43) Pub. Date: Mar. 12, 2009

(54) Oscillating scanning probe microscope

(76) Inventors: Paul E. West, Irvine, CA (US); Richard S. Becker, Anaheim, CA (US); Zhiqiang Peng, Yichun (CN)

Correspondence Address: William C. Milks, III;RUSSO & HALE LLP, 401 Florence Street, Palo Alto, CA, 94301, US

(21) Appl. No.: 12/214,081

(22) Filed: Jun. 16, 2008

Related U.S. Application Data
(63) Continuation of application No. 10/700,794, filed on Nov. 4, 2003, now abandoned.

(51) Int. Cl. G01N 13/10

(52) U.S. Cl. 850/5

(57) ABSTRACT

A scanning probe microscope that is easy to use, inexpensive to manufacture, has a fast scan rate, and has a broad range of applications. The oscillating sensor has a high resonance frequency. Because an oscillator is used, alignment of a laser is not required. Further, probe approach and scanning can be achieved at much faster rates.

### BACKGROUND OF THE INVENTION

1. Field of the Invention

The present invention relates generally to scanning probe microscopes and, more particularly, to oscillating scanning probe microscopes. Specifically, one embodiment of the present invention provides an oscillating scanning probe microscope system and method for fast scanning of samples.

2. REFERENCES
1) G. Binnig and H. Rohrer, Scanning Tunneling Microscopy—From Birth to Adolescence, Rev. of Mod. Phys., Vol. 59, No. 3, Part 1, July 1987, pp. 615-624.
2) Uber Glatte und Ebenheit als physikalisches und physiologishes Problem, Gustev Shmalz, Vereimes deutscher Ingenieure, Oct. 12, 1929, pp. 1461-1467.
3) Becker, et al., U.S. Pat. No. 2,728,222.
4) UK Patent Application No. 2,009,409 A.
5) R. Young, J. Ward, F. Scire, The Topografiner: An Instrument for Measuring Surface Microtopography, Rev. Sci. Inst., Vol. 43, No. 7, July 1972, pp. 999-1011.
6) G. Binnig, H. Rohrer, Ch. Gerber, and E. Weibel, Surface Studies by Scanning Tunneling Microscopy, Phys. Rev. Lett., Vol. 49, No. 1, 5 Jul. 1982, pp. 57-61.
7) G. Binnig and C. F. Quate, Atomic Force Microscope, Phys. Rev. Lett., Vol. 56, No. 9, 3 Mar. 1986, pp. 930-933.
8) Y. Martin, C. C. Williams, and H. K. Wickramasinghe, Atomic Force Microscope—Force Mapping and Profiling on a Sub 100-Å Scale, J. Appl. Phys., Vol. 61, No. 9, 15 May 1987, pp. 4723-4729.
9) Muramatsu, et al., U.S. Pat. No. 5,939,623.
10) Giessibl, U.S. Pat. No. 6,240,771.
11) Pohl, U.S. Pat. No. 4,851,671.
12) Karrai, U.S. Pat. No. 5,641,896.
13) Dransfeld, et al., U.S. Pat. No. 5,212,987.
14) W. H. J. Rensen, N. F. van Hulst, A. G. T. Ruiter, and P. E. West, Atomic Steps with Tuning-Fork-Based Noncontact Atomic Force Microscopy, Appl. Phys. Lett., Vol. 75, No. 11, 13 Sep. 1999, pp. 1640-1642.
15) H. Edwards, L. Taylor, W. Duncan, and A. J. Melmed, Fast, High-Resolution Atomic Force Microscopy Using a Quartz Tuning Fork as Actuator and Sensor, J. Appl. Phys., Vol. 82, No. 3, 1 Aug. 1997, pp. 980-984.
16) Hakamata, U.S. Pat. No. 5,214,279.
17) Omicron Product Literature.
18) Schnell, et al., U.S. Pat. No. 4,359,892.
19) Poirier, U.S. Pat. No. 5,574,278.
20) Edwards, et al., U.S. Pat. No. 6,094,971.
21) M. Weinmann, R. Radius, F. Assmus, and W. Engelhardt, Sensors and Actuators A, Vol. 37, No. 38, 1993, pp. 715-722.
22) G. M. McClelland, R. Erlandsson, and S. Chiang, Atomic Force Microscopy: General Principles and a New Implementation, IBM Tech. Disc. Bull., Vol. 30, No. 6, November 1987, pp. 343, et seq.
23) F. J. Giessibl, High-Speed Force Sensor for Force Microscopy and Profilometry Utilizing a Quartz Tuning Fork, Appl. Phys. Lett., Vol. 73, No. 26, 26 Dec. 1998, pp. 3956-3958.
24) A. Simon, R. Brunner, J. O. White, O. Hollricher, and O. Marti, Shear-Force Distance Control at Megahertz Frequencies for Near-Field Scanning Optical Microscopy, Rev. Sci. Inst., Vol. 72, No. 11, November 2001, pp. 4178-4182.
25) Y. Seo; J. H. Park, J. B. Moon, and W. Jhe, Fast-Scanning Shear-Force Microscopy Using a High-Frequency Dithering Probe, Appl. Phys. Lett., Vol. 77, No. 26, 25 Dec. 2000, pp. 4274-4276.
26) Schnell, et al., U.S. Pat. No. 4,359,892.

3. Description of the Prior Art

Traditional microscopes produce a magnified image of an object by focusing electromagnetic radiation, such as photons or electrons, on the surface of the object. Optical and electron microscopes can readily generate two-dimensional magnified images of an object's surface, with a magnification as great as 1,000× with an optical microscope, and as great as 100,000× with an electron microscope. Although these are powerful imaging tools, the images obtained are typically in a plane parallel to the surface of the object. Such microscopes do not readily supply the vertical dimensions of a nonplanar object's surface, for example, the height and depth of the surface features.

The scanning probe microscope (SPM), developed in the 1980's, uses a sharp probe to magnify an object's surface. With the scanning probe microscope, it is possible to image an object's surface topography with extremely high magnification, as great as 1,000,000×. The magnification of a scanning probe microscope is obtained in three dimensions, namely, the horizontal X-Y plane and the vertical Z dimension in the Cartesian coordinate system. As acknowledged by Binnig and Rohrer (1), the inventors of the scanning tunneling microscope (STM), this powerful technique had its origins in the stylus profiler.

Considered in more detail, magnification of the vertical surface features of an object, that is, those non-planar features extending in the vertical direction from the surface of an object, have historically been measured by a stylus profiler. An example of an early stylus profiler is shown in FIG. 1. This stylus profiler, invented by Shmalz (2) in 1929, utilized an optical lever arm to monitor the motion of a sharp probe mounted at the end of a cantilever. A magnified profile of the surface was generated by recording the motion of the probe on photographic paper. This type of “microscope” generated profile “images” with a magnification of greater than 1,000×.

A common problem with stylus profilers is the possible bending of the probe from collisions with surface features of the object. Such “probe bending” is a result of horizontal forces on the probe caused when the probe encounters relatively large features on the surface. This problem was first addressed by Becker (3) in 1950 and later by Lee (4). Both Becker and Lee suggested oscillating the probe from a null position above the surface of the object into contact with the surface. Becker remarked that when using this vibrating stylus profiling method for imaging the surface of an object, the detail of the images would depend on the sharpness of the probe.

Young (5) demonstrated a non-contact type of stylus profiler. In his profiler, called the Topografiner, Young used the fact that the electron field emission current between a sharp metal probe and the surface of an object is very dependent on the probe-sample distance for electrically conductive objects. In the Topografiner, the probe was mounted directly on a piezoelectric ceramic used to move the probe in a vertical direction above the surface. An electronic feedback circuit monitored the electron field emission and supplied a current used to drive the piezoceramic to maintain the probe-sample spacing fixed. Also, using piezoelectric ceramics, the probe was scanned at the fixed spacing from the surface in the horizontal (X-Y) plane. By monitoring the X-Y and Z positions of the probe, a three-dimensional image of the surface of the object was constructed. The resolution of Young's instrument was limited by the Topografiner's vibrations.

Binnig and Rohrer demonstrated that by controlling the vibrations of an instrument very similar to Young's Topografiner, it was possible to monitor the electron tunneling current between a sharp probe and a sample. Since electron tunneling current is much more sensitive than electron field emissions, the probe was able to scan very close to the surface of the object. The results were astounding; Binnig and Rohrer were able to image individual silicon atoms on the surface of a sample using an STM. Although the STM was considered a fundamental advance for scientific research, it had limited applications, because the sample was required to be electrically conductive.

Even before the invention of the scanning tunneling microscope to image electrically conductive samples, a stylus profiler that used a feedback system to maintain a constant force on a sample's surface was disclosed by Schnell, et al. (18). In his device, Schnell used sensors to measure the force of the probe on the surface of an object, and with a feedback electronic circuit; he was able to use a piezoelectric material to move the probe up and down over the surface to maintain the force fixed. With this device, it was possible to maintain a constant force on a sample while scanning, and non-conductive samples and soft samples could be imaged.

A major improvement occurred when Binnig and Quate (7) demonstrated the atomic force microscope (AFM). Using an ultra-small probe tip at the end of a cantilever, the AFM achieved extremely high spatial resolutions. Initially, the motion of the cantilever was monitored with an STM having a sharp probe to sense deflection of the cantilever. However, it was soon realized that a “light lever,” design similar to the optical system first used by Shmalz, could be used for measuring the motion of the cantilever. In their initial publication regarding the AFM, Binnig and Quate proposed that the sensitivity of the AFM could be improved by vibrating the cantilever above the surface as the cantilever (or sample) was scanned.

The first practical demonstration of the vibrating cantilever technique in an AFM was by Wickramasinghe (8). In his device, Wickramasinghe used an optical interferometer to measure the changes in the amplitude or phase of a cantilever's vibration and regulate the force between the probe and sample. Using this optical technique, oscillation amplitudes between 0.3 and 300 nm were achieved. Because the probe came in close contact with the surface of the sample on each oscillation, Wickramasinghe was able to sense characteristics of the materials on the surface. The differences between photoresist and silicon were readily observed.

Light lever measurement techniques are adequate for measuring the deflection of a cantilever in an AFM. However, light levers can be difficult to use because precision alignment of a light source, such as a laser beam, on a microscopic cantilever is required.

An alternative to the light lever for measuring the force between a probe and sample is to use a vibrating crystal, first suggested by Pohl (11). Further, Dransfeld (13) demonstrated that a vibrating crystal can be used to measure acoustic waves between a vibrating crystal and the surface of a sample. However, acoustic waves require that the probe be greater than several microns from the surface. Karrai (12) demonstrated that a tuning fork crystal can be used to control the spacing between an optical fiber and a sample in a near-field scanning optical microscope (NSOM). Later Duncan (15) (20) showed that a needle can be directly attached to a tuning fork crystal with the probe vibrated perpendicularly to the surface of a sample; however, Duncan's device required that the probe “tap” the sample and thus risk breaking the sharp probe.

West (14) showed that a tuning fork can be used with a cantilever with the probe vibrated in a “non-contact” mode, enabling atomic terraces to be imaged. More recently, Giessibl (23) used a crystal vibrated perpendicularly to the surface of a sample to demonstrate that atomic resolution could be achieved.

In addition to the force sensor described above, commercially available atomic force microscopes have several components that are essential for operation. These include X,Y,Z translators for moving the probe relative to the sample to select the region of the sample to be scanned prior to the initiation of scanning and a high resolution x,y,z scanner for precisely moving the probe or sample while the surface of the sample is being scanned. Not essential, but very helpful, is an optical microscope for helping to position the probe over the region that will be scanned.

Considered in more detail, FIG. 2 is a block diagram of an atomic force microscope illustrating the relative placement of the primary subsystems. The AFM includes a base 1, on which are mounted the X-Y translator 2 and Z translator 3. As shown in FIG. 2, the Z translator 3 may comprise a first Z translator 3A and a second Z translator 3B so that an AFM scanner 4 can be tilted with respect to a sample 5 disposed on a sample holder 6. A probe 7 is mounted to a cantilever 8 which is in turn mounted to the AFM scanner 4. As shown in FIG. 2, the AFM scanner 4 houses the x,y,z scanner to scan the probe 7 and maintain a constant force between the probe and the sample 5. Alternatively, the x,y,z scanner can be associated with the X,Y,Z translators. An optical microscope 9 is preferably included to view the end of the cantilever 8 to which the probe 7 is mounted through an aperture 9 in the AFM scanner 4 to enable an operator to position the probe above a region of the sample to be imaged.

Although scanning probe microscopes have many advantages when compared to traditional microscopes, a major disadvantage is the amount of time required to complete an image. One problem is that approaching the probe toward the surface of the sample, or vice versa, requires care to avoid crashing the probe on the surface and, consequently, requires an appreciable amount of time. To assure that the probe is not damaged by the sample during tip approach, a “woodpecker” approach is typically used. In accordance with that approach, if the fine z piezoelectric ceramic can move the probe 10 microns, then a Z translator motor is used to move the probe 2 microns. After the motor moves a 2-micron step, the z piezoceramic is extended to see if the surface is detected. This procedure is repeated over and over again. Consequently, the technique may take several minutes to move a few millimeters towards the surface.

Also, attempts have been made to improve the scanning speed of a scanning probe microscope. For example, Quate scanned surfaces in less than a second with an STM; however, the scanned area was very small and not useful for commercial applications. Several attempts were made by scanning probe microscope manufacturers to develop faster scanning probe microscopes. However, progress was limited, because the commercial products did not solve critical problems required for fast scanning. For example, the piezoelectric ceramic scanners in commercial products may shake apart due to vibrations created while scanning.

It would therefore be desirable to provide a scanning probe microscope that enables a probe to be quickly positioned with respect to the surface of a sample while avoiding the risk of damage to the probe. It would also be desirable to provide fast scanning in a scanning probe microscope. Additionally, it would be desirable to enable an operator to readily select a region of a sample to be imaged. The scanning probe microscope in accordance with the various embodiments of the present invention facilitates alignment of the probe to the region of the sample to be scanned, safe and quick approach of the probe to the surface of the sample, and fast scanning of the sample.

### SUMMARY OF THE INVENTION

It is an objective of the present invention to provide a scanning probe microscope that is easy to use, scans samples very rapidly, and has a broad range of applications. One embodiment of the present invention provides an oscillating scanning probe microscope that uses a crystal oscillator, for example, a quartz crystal cross oscillator, for the sensor in combination with innovative sensing and feedback electronics, software, and mechanical subsystems.

One embodiment of the present invention provides a scanning probe microscope system for imaging the surface of a sample, comprising: a sensor comprising an oscillator for producing a signal; a probe connected to the sensor; an optical microscope for viewing the location of the probe mounted to the sensor; means for scanning the probe with respect to the sample; sensor electronics connected to the sensor for monitoring the signal produced by the sensor; and means responsive to the signal produced by the sensor electronics for moving the probe toward or away from the surface of the sample. In accordance with another embodiment of the present invention, a scanning probe microscope system for imaging the surface of a sample is provided, comprising: a sensor comprising an oscillator for producing a signal; a probe connected to the sensor; means for scanning the probe with respect to the sample comprising a first electromechanical transducer and a second electromechanical transducer, the first electromechanical transducer having a first resonant frequency and the second electromechanical transducer having a second resonant frequency substantially lower than the first resonant frequency; sensor electronics connected to the sensor for monitoring the signal produced by the sensor; and means responsive to the signal produced by the sensor electronics for moving the probe toward or away from the surface of the sample comprising a third electromechanical transducer having a third resonant frequency substantially higher than the first resonant frequency.

Also, one embodiment of the method for operating a scanning probe microscope for initiating scanning the surface of a sample in accordance with the present invention comprises the steps of: providing a sensor comprising an oscillator; operating the oscillator over a range of frequencies; determining the amplitude of current over the frequency range; selecting a frequency from a current versus frequency curve; positioning a probe connected to the oscillator with respect to a region of the sample surface to be scanned using an optical microscope; moving the probe toward the sample as the oscillator vibrates the probe; detecting an acoustic frequency produced by the oscillator as the vibrating probe is moved to within approximately 100 nanometers of the sample; detecting atomic force interaction when the probe is moved to proximity of the sample; and scanning the sample after the probe is detected to be in proximity to the sample. Preferably, the method further comprises the step of raising the probe so that the probe does not follow the surface on retrace during raster scanning.

The foregoing and other objects, features, and advantages of the present invention will become more readily apparent from the following detailed description of various embodiments, which proceeds with reference to the accompanying drawing.

### BRIEF DESCRIPTION OF THE DRAWING

The various embodiments of the present invention will be described in conjunction with the accompanying figures of the drawing to facilitate an understanding of the present invention. In the figures, like reference numerals refer to like elements. In the drawing:

FIG. 1 illustrates a conventional stylus profiler;

FIG. 2 is a block diagram of a conventional atomic force microscope illustrating the relative placement of the primary subsystems;

FIG. 3 is a diagram illustrating a sensor comprising one embodiment of the scanning probe microscope in accordance with the present invention;

FIG. 4A shows alternative configurations of the probe mounted to the oscillator shown in FIG. 3 in accordance with various embodiments of the present invention;

FIG. 4B shows the probe mounted to a cantilever in turn mounted to the oscillator shown in FIG. 3 in accordance with another embodiment of the present invention;

FIGS. 5A, 5B, and 5C are block diagrams of sensor electronics comprising various embodiments of the scanning probe microscope in accordance with the present invention;

FIG. 6 illustrates a current versus frequency curve for an oscillator that may be used as the sensor shown in FIG. 3;

FIG. 7 shows the effect of the set-point frequency on the “approach” curve when the sensor shown in FIG. 4 is used;

FIG. 8 illustrates associated changes in frequency of the resonant system comprising the sensor shown in FIG. 3 as the probe is moved towards a hard surface;

FIG. 9 is a block diagram of a feedback loop comprising one embodiment of the scanning probe microscope in accordance with the present invention;

FIG. 10 is a block diagram of an alternative feedback loop comprising one embodiment of the scanning probe microscope in accordance with the present invention; and

FIG. 11 is a flow chart of one embodiment of the probe approach and scanning method in accordance with the present invention.

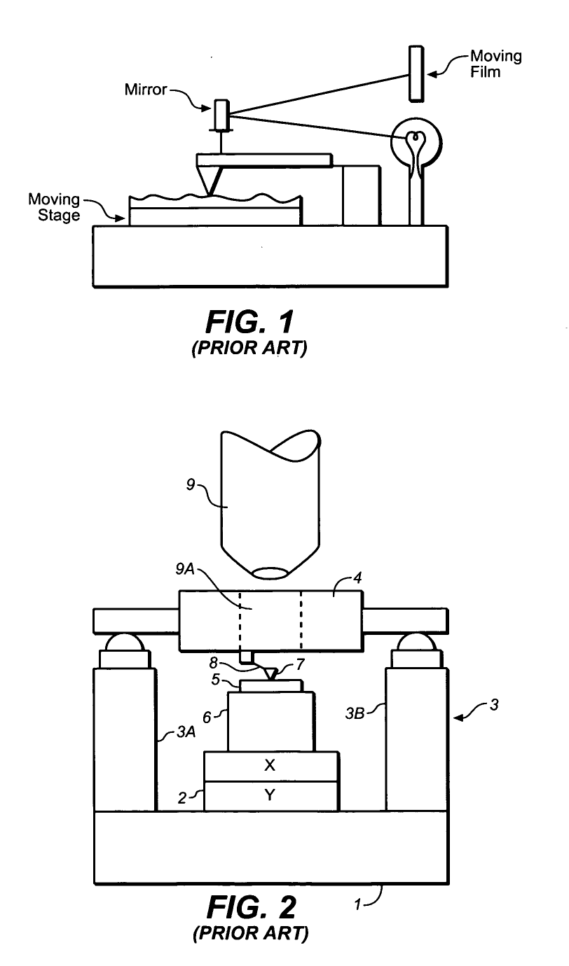

### DETAILED DESCRIPTION OF THE PREFERRED EMBODIMENTS

The present invention is particularly applicable to a scanning probe microscope, and it is in this context that the various embodiments of the present invention will be described. One element of the various embodiments of the scanning probe microscope in accordance with the present invention is a sensor.

An oscillator is preferably used as the sensor in the various embodiments of the scanning probe microscope in accordance with the present invention. There are numerous types of oscillators, for example, a bulk crystal, tuning fork, or cross oscillator. Although there are a number of types of crystal oscillators that may be used, such as tuning forks and bulk crystals, for the remainder of this description, a crystal cross oscillator will be described by way of example.

In accordance with one embodiment of the present invention, a probe 10 may be mounted proximate the end of an elongated arm 12 of a crystal cross oscillator 14, as shown in FIG. 3. Typically, quartz is preferred as the oscillator material in this type of sensor. However, any type of material that produces an electrical signal when activated mechanically may be used. Other examples of material from which the crystal cross oscillator 14 may be constructed include silicon, as well as traditional piezoelectric materials, for example, lead titanate.

As shown in FIG. 3, the probe 10 extends downwardly from the arm 12 toward a sample (not shown). Using a quartz crystal cross oscillator 14 for the sensor, a primary motion of the probe 10 in this sensor is horizontal to the surface of a sample being scanned, as shown by the double-headed arrow appearing in FIG. 3, and not perpendicular to the surface, to provide what is generally referred to as a “shear force” sensor. A shear force sensor has the advantage that the probe 10 does not “tap” the surface of a sample and risk being easily broken due to contact with the surface.

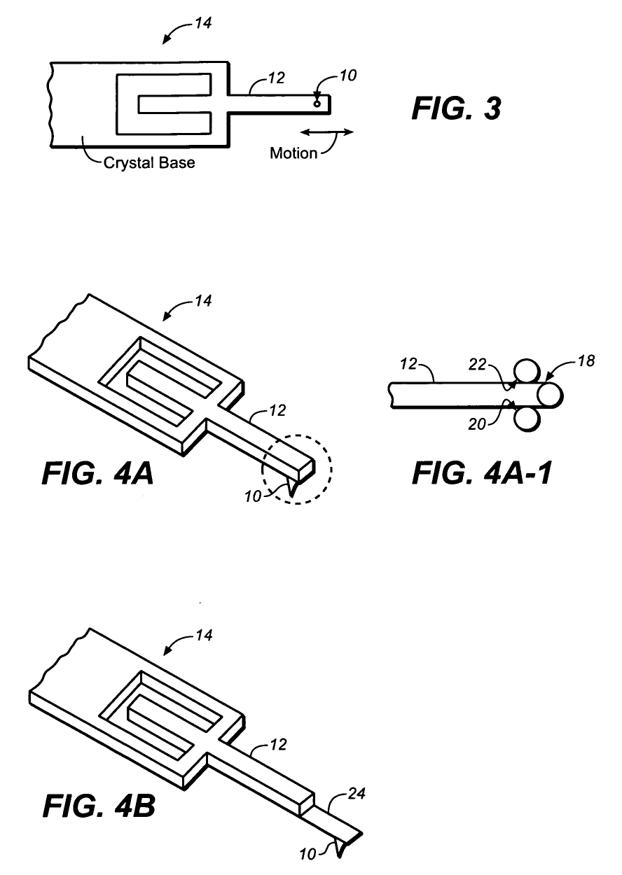

Several alternative configurations of the probe 10 mounted to the arm 12 of the quartz crystal cross oscillator 14 are contemplated, as shown in FIG. 4A. For example, the probe 10 may be mounted to the distal end of the arm 12 at a location 18. Alternatively, the probe 10 may be mounted on a longitudinal face of the arm 12, for example, on a starboard face 20 or a port face 22, as also shown in FIG. 4A.

Several techniques may be employed for mounting the probe 10 proximate the end of the arm 12 of the quartz crystal cross oscillator 14. For example, the probe 10 may be attached to the arm 12 after the cross oscillator 14 is manufactured, such as by adhesively bonding the probe to the arm. Or, alternatively, the probe 10 may be fabricated directly on the arm 12 by a micro-fabrication process.

In an alternative embodiment shown in FIG. 4B, a cantilever 24 is mounted to the distal end 18 of the arm 12 of the quartz crystal cross oscillator 14. The probe 10 is in turn mounted to the cantilever 24.

The motion or vibration of the probe 10 indicated by the double-headed arrow shown in FIG. 3 may be in a rapid scan direction or perpendicular to the rapid scan direction. The rapid scan direction is defined by the series of adjacent points at which measurements of force, for example, are obtained to construct an image, the series of points forming a line across the region of the sample being scanned. By way of example, the rapid scan direction may be along the X axis with reference to the Cartesian coordinate system. The slow scan direction is defined as the direction perpendicular to the rapid scan direction as the probe 10 is moved in the orthogonal direction to raster-scan the region of the sample. By way of example, the slow scan direction may be along the Y axis with reference to the Cartesian coordinate system.

Alternatively, in a less preferred embodiment, the motion of the probe 10 may be vertical to the surface of a sample. Such a motion may be achieved by placing electrodes on the quartz crystal cross oscillator 14 and supplying current to the electrodes, as is well-known to persons skilled in the art. Or, if the oscillator 14 is constructed from metal or an insulator, an external device creating an alternating electrical field may be used to produce the oscillating motion of the probe 10, as is also well-known to persons skilled in the art. The external device may cause motion by electrostatic or magnetic electrical coupling forces.

A significant advantage of using a cross oscillator as the sensor is that the probe 10 is positioned proximate the end of the arm 12 of the cross oscillator 14 to enable an operator to readily view the position of the probe through an optical microscope (FIG. 2). The optical microscope can be used for positioning the probe 10 with respect to a region of interest on the sample. The use of the optical microscope for other functions will become apparent later in this description.

Furthermore, using a crystal oscillator for the sensor in an atomic force microscope has additional advantages. For example, there is an electrical signal from the quartz crystal cross oscillator 14, that results from “acoustic” coupling between the probe 10 and a sample at interstitial distances or spacings as great as 100 nm. The onset of the acoustic coupling may be detected due to dampening of the amplitude of oscillations at acoustic frequencies to sense proximity of the probe 10 to a sample within probe-sample distances on the order of 100 nm. Then, “near field” dampening occurs from a “mechanical” interaction when the distance from the probe 10 to the surface of the sample decreases to a few nanometers. Monitoring the dampening of the amplitude of oscillations of the cross oscillator 14 in these different regimes may be used to control a Z translator to quickly move the probe 10 into scanning position with respect to the surface of a sample while substantially minimizing the risk of the probe crashing into the surface.

It is desirable that the probe 10 be easily mounted in the scanning mechanism of the scanning probe microscope. Because the cross oscillator 14 may be very small, the oscillator is preferably attached to a substrate, or holder, that can be inserted into the scanning probe microscope, as is well-known by persons skilled in the art. Attachment may be achieved with magnets or a mechanical clip, for example. A tool may be needed for rigidly placing the oscillator/holder assembly into the scanning probe microscope, as is also well-known by persons skilled in the art.

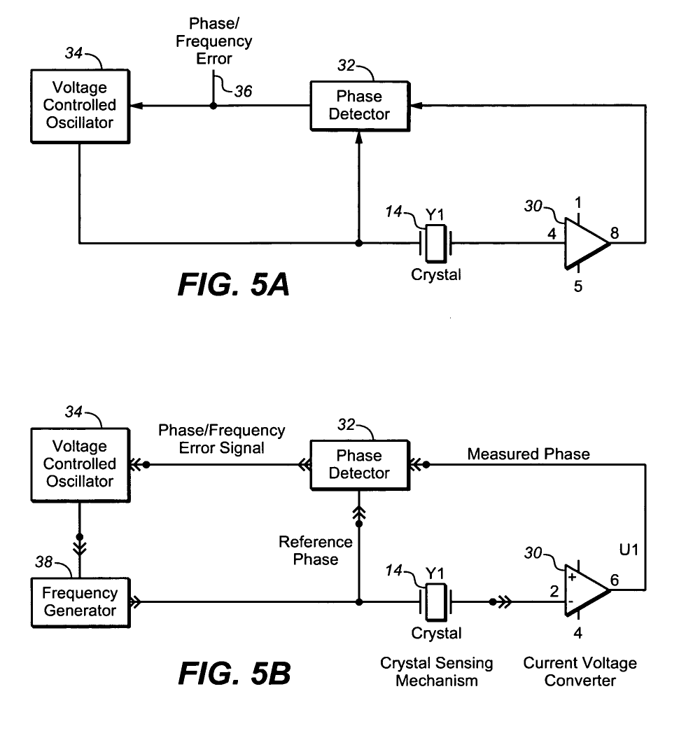

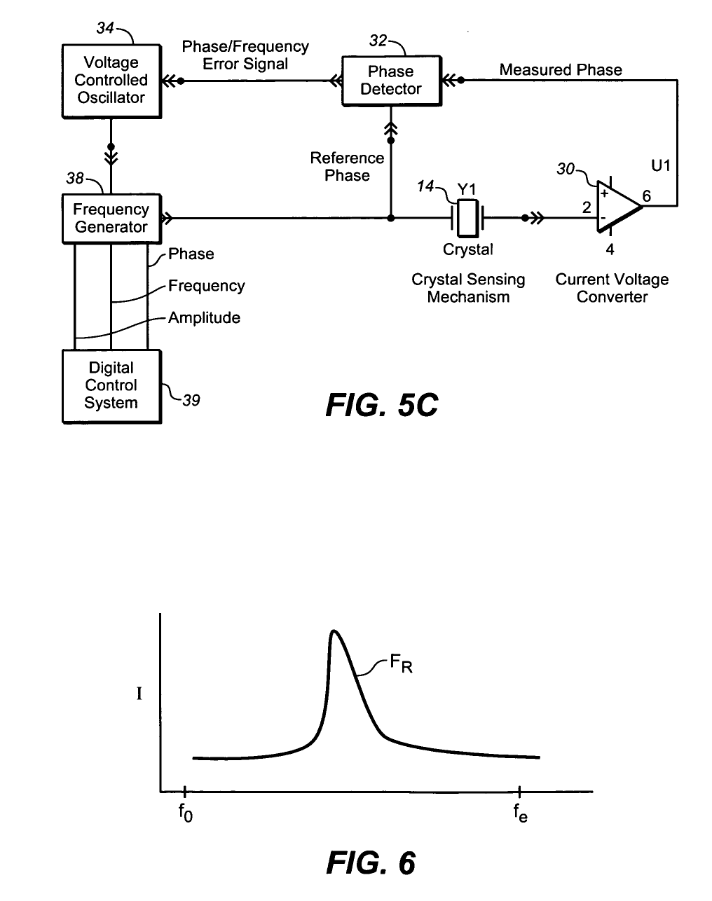

Another element of the various embodiments of the scanning probe microscope in accordance with the present invention is sensor electronics. Sensor electronics are provided for producing an electrical signal that indicates the distances between the probe 10 and the surface of the sample (not shown) that is being scanned. The sensor electronics may measure a change in either a) phase, b) frequency, or c) amplitude of the electrical signal produced by the crystal oscillator, for example, the quartz crystal cross oscillator 14. The cross oscillator 14 can either be self-oscillated or it may be externally oscillated, as described above. Preferably, the oscillation frequency is at the resonant frequency of the cross oscillator. Examples of sensor electronics are illustrated in FIGS. 5A, 5B, and 5C.

As shown in FIG. 5A, the electrical signal from the crystal oscillator, for example, the quartz crystal cross oscillator 14, may be amplified by an operational amplifier 30, and the amplified signal is connected to one input of a phase detector 32. The excitation signal for the oscillator 14 is supplied by a voltage controlled oscillator (VCO) 34. The excitation signal from the output of the VCO 34 is also connected to a second input of the phase detector 32. The phase detector 32 outputs an error signal when the phase of the oscillator signal changes with respect to the phase of the VCO output signal indicative of a shift in the frequency of the oscillator signal as a result of atomic force interactions between the probe 10 and a sample. Preferably, the cross oscillator 14 is excited at substantially the oscillator's resonance frequency, f_{R}. Consequently, the error signal produced by the phase detector 32 follows the shifts away from the resonance frequency due to the atomic force interactions. The error signal is in turn fed to the VCO 34 to adjust the excitation signal supplied by the VCO to the cross oscillator 14, forming a phase locked loop to maintain operation of the oscillator 14 at or near the oscillator's resonance frequency. The phase/frequency error signal indicative of the atomic force interactions is also connected to an output line 36 and processed, for example, to construct an image of the surface of the sample being scanned.

FIG. 5B is a block diagram of sensor electronics in accordance with another embodiment of the scanning probe microscope of the present invention. As in the case of the sensor electronics shown in FIG. 5A, the phase/frequency error signal tracks the shifts away from the resonance frequency of the crystal oscillator, for example, the quartz crystal cross oscillator 14, as a result of atomic force interactions between the probe 10 and a sample. In addition, a frequency generator 38 supplies a signal over a range of frequencies near the resonance frequency, f_{R}, of the cross oscillator 14. By sweeping the frequency generator 38 from a starting frequency, f₀, to an ending frequency, fₑ, and monitoring the output signal from the cross oscillator 14, the resonant frequency, f_{R}, of the oscillator can be determined, as shown in FIG. 6. Typically, software controls sweeping the frequency.

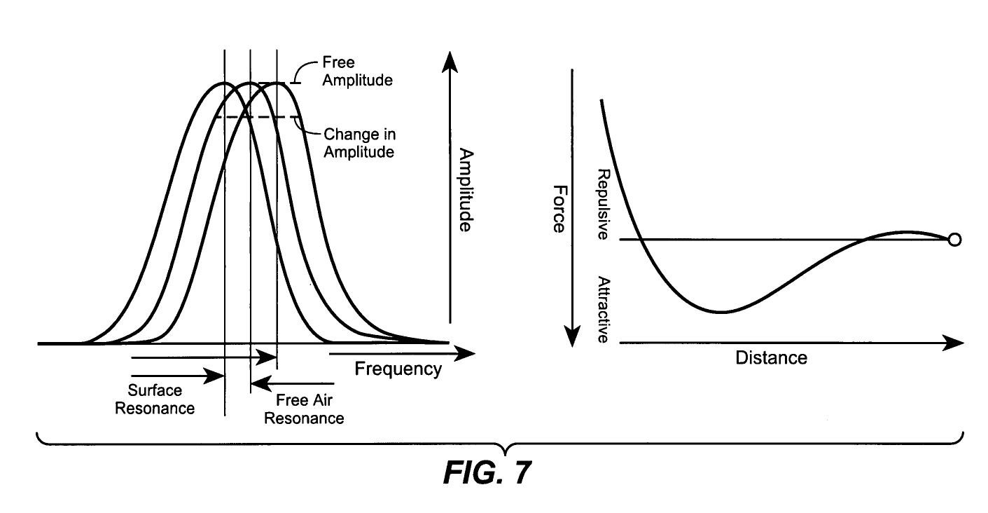

When scanning a sample, it is advantageous to operate the crystal oscillator, for example, the quartz crystal cross oscillator 14, at or near its resonance frequency, f_{R}. Even off the resonance frequency, however, the cross oscillator 14 will operate, but the sensitivity to external forces is diminished. FIG. 7 shows the effect of the set-point frequency on the “approach” curve when the cross oscillator 14 is used. It is clear that the optimum frequency for operation is f_{R}.

Preferably, the sensor electronics monitors the change in the resonant frequency of the signal produced by the crystal oscillator, for example, the quartz crystal cross oscillator 14, as the probe 10 approaches the surface of a sample. A method for monitoring the change in resonant frequency is to compare the frequency of the resonant system with a known frequency, as will now be described in more detail.

Referring again to FIG. 5B, the frequency generator 38 provides a signal that excites the crystal oscillator, for example, the quartz crystal cross oscillator 14, that moves the probe 10, and compares the phase of the VCO signal to the original frequency generator signal. With feedback from the phase detector 32 to the VCO 34, the speed of response of the crystal oscillator 14 is increased.

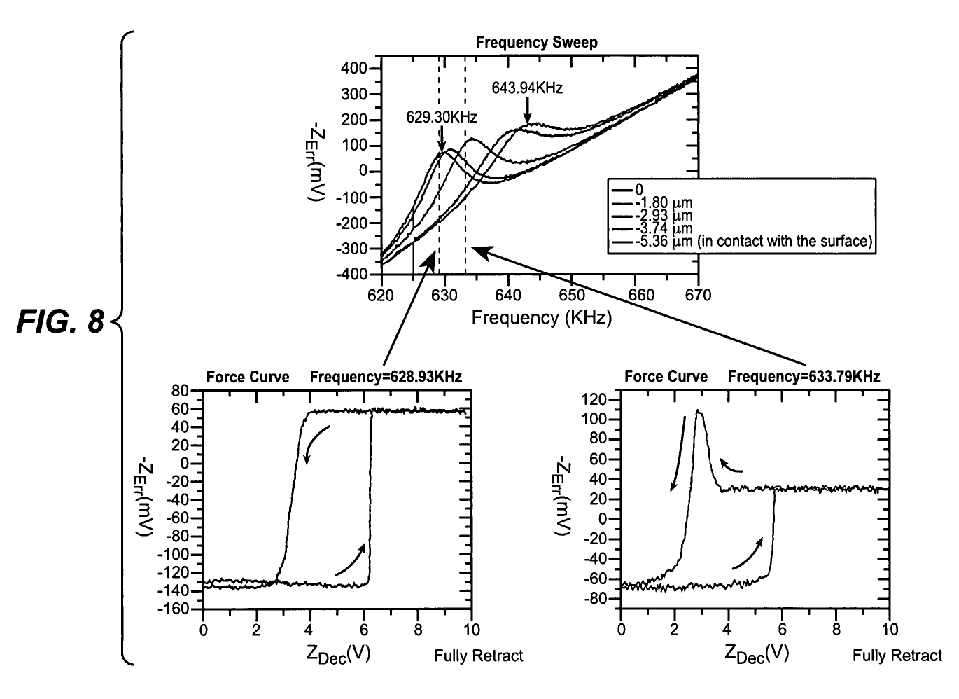

On the one hand, if the signal produced by the VCO 34 and the original signal produced by the frequency generator 38 are in phase, the probe 10 is moving toward the surface of a sample. On the other hand if the two signals are out of phase, the probe is moving away from the surface. Consequently, the phase of the resonance curve can be determined. Such a capability is needed for establishing quantitative information from force/distance curves or from modes such as magnetic force microscopy or electrostatic force microscopy. FIG. 8 illustrates associated changes in frequency as the probe 10 is moved towards a hard surface. The resonance curves change substantially when the probe 10 is moved from a distance of approximately 5 microns to near-contact with the surface. From FIG. 8 it is clear that the set-point used for probe approach and for scanning is preferably set at the left side of the resonance curve.

FIG. 5C is a block diagram of sensor electronics in accordance with a further embodiment of the scanning probe microscope of the present invention. As in the case of the sensor electronics shown in FIG. 5B, the phase/frequency error signal tracks the shifts away from the resonance frequency of the crystal oscillator, for example, the quartz crystal cross oscillator 14, as a result of atomic force interactions between the probe 10 and a sample. Additionally, a control system 39, preferably, a digital control system, is connected to the frequency generator 38 to control amplitude, phase, and frequency of the signal exciting the cross oscillator 14.

As the probe 10 moves closer to the surface of a sample, the amplitude/frequency shifts. However, one cannot discern whether the amplitude/frequency shift is due to increased or decreased atomic force interaction. The change in amplitude/frequency may be caused by either. However, if the probe 10 is moved closer to the surface by a small amount at a new frequency produced by the frequency generator 38, and the change in amplitude/frequency is measured, one can determine the direction of the amplitude/frequency change, and therefore determine the relationship between the motion and change in amplitude/frequency.

As shown in FIGS. 5A, 5B, and 5C, the crystal oscillator, for example, the quartz crystal cross oscillator 14, is self-excited. Alternatively, one contemplated modification is to provide an external modulator proximate to the crystal oscillator and to further provide an excitation circuit for supplying an excitation signal to drive the modulator to impart vibration to the oscillator. For example, the external modulator may comprise a dither piezoelectric ceramic.

Before a scan of a sample can be initiated using a scanning probe microscope, for example, an atomic force microscope, it is necessary to move the probe 10 to a distance relative to the surface of the sample at which the probe interacts with the nanoscopic forces associated with the surface features. This probe “approach” may require a substantial amount of time in conventional scanning probe microscopes and, consequently, reduce the usefulness of the scanning probe microscope.

In accordance with one embodiment of the method of the present invention, before the probe approach is commenced, it is preferable to select the optimal frequency set point for the probe approach. This is preferably achieved by generating a frequency sweep curve and selecting a frequency for the frequency generator 38. It should be pointed out that the frequency used for probe approach may differ from the frequency during scanning.

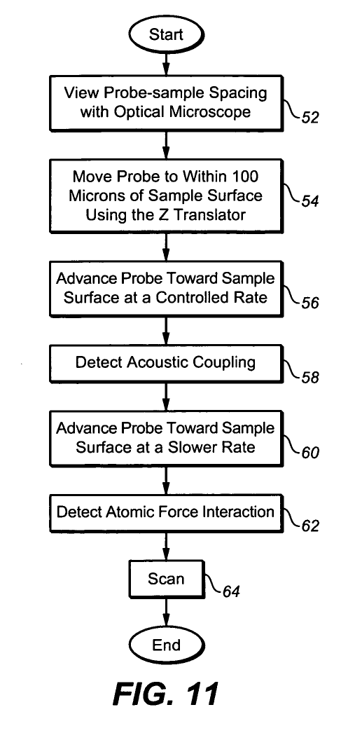

Two techniques may be employed for improving the speed of probe approach. First, an optical microscope may be used to focus on the top of the crystal oscillator, for example, the quartz crystal cross oscillator 14, and then on the surface of the sample, as indicated by the numeral 52 shown in FIG. 11. Then, because the thickness of the arm 12 of the cross oscillator 14 is known, the probe 10 may be rapidly moved toward the surface by the Z translator until the probe is less than 100 microns from the surface, as indicated by the numeral 54 shown in FIG. 11. Second, the probe 10 is advanced toward the surface at a controlled rate, as indicated by the numeral 56 shown in FIG. 11, while the vibration amplitude is monitored. The onset of acoustic coupling may be detected, as indicated by the numeral 58 shown in FIG. 11, when the probe 10 is approximately 100 nm from the surface. The probe approach may then be slowed down when acoustic coupling is observed, as indicated by the numeral 60 shown in FIG. 11. Thereafter, the sensor electronics may detect the onset of atomic interaction forces when the probe 10 nears scanning position, as indicated by the numeral 62 shown in FIG. 11.

In order for a scanning probe microscope to have a high scanning speed, the frequency of the crystal oscillator, for example, the quartz crystal cross oscillator 14, and associated sensor electronics is preferably high, for example, greater than 400 kHz. In general, there are preferably at least five oscillations of the cross oscillator 14 for each data point to be obtained for an AFM image, for example. In a scanning probe microscope, the maximum distance between data points is preferably 1.0 nm or less. For a 10 micron by 10 micron scan region that has 256 lines and is scanned in less than 1.0 second, the optimal resonance frequency of the cross oscillator 14 may be calculated as:

10,000 nm/1 nm=10,000 data points

1/256 seconds=0.0039 seconds

Thus, the resonance frequency is approximately:

10,000/0.0039×5=12.8 MHz.

If the scan time is allowed to increase to 30.0 seconds, then the resonance frequency is approximately:

10,000/0.1172×5=426.621 kHz

Consequently, there is a substantial advantage if the resonance frequency of the cross oscillator 14 is greater than 400 kHz in order to increase scan speed. For example, as shown in FIG. 8, the resonance frequency of the cross oscillator 14 may be between approximately 623 kHz and 634 kHz.

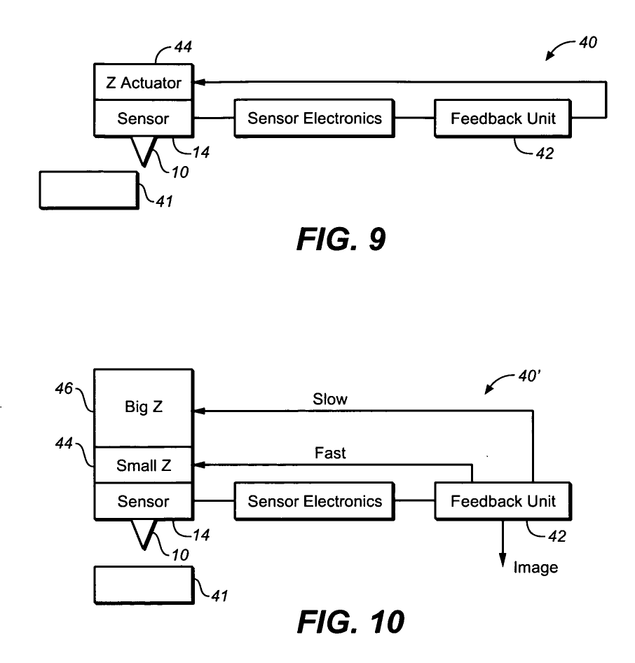

There are several requirements that must be met so that a scanning force microscope, for example, an AFM, can scan a sample very rapidly, as indicated by the numeral 64 shown in FIG. 11. First, scanning a sample at high speeds requires a feedback circuit that can receive the signal from the sensor electronics and activate an electromechanical transducer rapidly enough that the probe 10 does not crash into the surface features on the surface of the sample while scanning. As shown in FIG. 9, one embodiment of the scanning probe microscope in accordance with the present invention comprises a feedback loop 40 to control the movement of the probe 10 perpendicular to the surface of a sample 41. The feedback loop 40 comprises the sensor, preferably the quartz crystal cross oscillator 14. The feedback loop 40 also comprises the sensor electronics described above in conjunction with FIGS. 5A, 5B, and 5C. The feedback loop 40 further comprises a feedback unit 42 to process the error signal produced by the sensor electronics responsive to atomic force interactions and to produce a control signal supplied to a fine z actuator 44 Typically, the “slowest” component in the feedback loop 40 controlling the movement of the probe 10 relative to the surface of the sample 41 in an AFM is the fine z actuator 44, for example, an electromechanical transducer such as a piezoelectric ceramic actuator. Because the fine z actuator 44 is an electromechanical device, it undergoes a 180° phase shift at its first resonance.

Typically, the larger the motion of the fine z actuator 44, the lower its resonance frequency. Consequently, it is advantageous to have the fine z actuator 44 that moves the probe/sensor be as small as possible, and, concomitantly, the fine z actuator will have a small mechanical displacement capability. Large Z motions in an AFM are typically required to take into account the tilt between the probe 10 and the sample 41. Accordingly, as shown in FIG. 10, a feedback loop 40′ may additionally comprise a coarse z actuator 46, for example, an electromechanical transducer such as a piezoelectric ceramic actuator.

Therefore, the feedback loop 40′ with a slow and a fast response is preferably provided, as shown in FIG. 10. Two different sized piezoelectric ceramics may support the probe 10, a small ceramic for scanning over the surface features of interest and a large ceramic for following the tilt between the probe and sample 41. The image is constructed by processing the error signal from the fast feedback loop.

Second, the AFM scanner head is preferably held by a Z motor system that allows leveling the probe motion with respect to the sample, as described above in conjunction with FIG. 2. Because a majority of regions of interest on the surface of a sample scanned with an AFM have surface features that are much less than 100 nm in depth, the z piezoelectric ceramic would then only need to have a 0.5 micron displacement, for example. The 0.5 micron piezoelectric ceramic has a much higher resonance frequency than an 8 micron piezoelectric ceramic typically used in conventional AFMs. A software algorithm is used for leveling the AFM scanner head with respect to the surface of the sample before scanning is initiated.

Third, an X-Y scanner that has minimal Z motion is preferably used. Also, the electromechanical transducers comprising the scanner must be able to scan the probe over the surface of the sample very rapidly. The scanner must be able to withstand the vibrations created by the rapid motion of the probe 10 over the surface. Unwanted vibrations, and resonances in the scanner, result in rapid failure of the scanner, as well as unwanted artifacts in images.

Optimizing the scanner structure for high speed scanning may be achieved by using two different sizes or types of electromechanical transducers for producing the X and the Y motion of the probe 10. It is critical that the resonant frequency of the actuator producing motion along the slower scanning axis be substantially less than the resonant frequency of the actuator producing motion along the faster scanning axis. Further, the resonant frequency of the Z axis electromechanical transducer must be substantially greater than the resonant frequency of the X and Y axis electromechanical transducers, viz.:

R(Z)>>R(X)>>R(Y),

where R(Z) is the resonant frequency of the Z axis actuator;
R(X) is the resonant frequency of the X axis actuator (the faster scanning axis); and
R(Y) is the resonant frequency of the Y axis actuator (the slower scanning axis).
When the above conditions are met, the motion along one of the axes will not affect the motion along the other axes.

The electromechanical transducers for the X axis and Y axis motion may be the same type of actuator, for example, a piezoelectric ceramic. Or, the X and Y axis electromechanical transducers may be different types of actuators. For example, the slower motion Y axis actuator may be a conventional piezoelectric ceramic, and the faster motion X axis actuator may be a voice coil. It is also contemplated to reduce unwanted resonances in the scanning system by using a curved raster signal, instead of a rounded raster signal. Additionally, the scanning speed may be increased by moving the probe 10 away the surface of the sample 41 on the retrace.

While the foregoing description has been with reference to particular embodiments of the present invention, it will be appreciated by those skilled in the art that changes in these embodiments may be made without departing from the principles and spirit of the invention, the scope of which is defined by the appended claims.

What is claimed is:

1. A scanning probe microscope for imaging the surface of a sample, comprising:
a sensor comprising an oscillator for producing a signal;
a probe connected to the sensor;
an optical microscope for viewing the location of the probe mounted to the sensor;
means for scanning the probe with respect to the sample;
sensor electronics connected to the sensor for monitoring the signal produced by the sensor; and
means responsive to the signal produced by the sensor electronics for moving the probe toward or away from the surface of the sample.

2. The scanning probe microscope according to claim 1 wherein the oscillator is a resonant crystal oscillator.

3. The scanning probe microscope system according to claim 2 wherein the resonant crystal oscillator is a quartz crystal cross oscillator.

4. The scanning probe microscope according to claim 2 wherein the resonant crystal oscillator is self-excited.

5. The scanning probe microscope according to claim 3 wherein the quartz crystal cross oscillator is self-excited.

6. The scanning probe microscope according to claim 2 wherein an external modulator is provided proximate to the resonant crystal oscillator, and further comprising an excitation circuit for supplying an excitation signal to drive the modulator.

7. The scanning probe microscope according to claim 3 wherein an external modulator is provided proximate to the quartz crystal cross oscillator, and further comprising an excitation circuit for supplying an excitation signal to drive the modulator.

8. The scanning probe microscope according to claim 1 wherein the scanning probe microscope is operable in a mode selected from the modes of magnetic force microscopy and electrostatic force microscopy and the signal produced by the sensor is used to determine characteristics of the sample selected from among the characteristics of magnetic and electrostatic properties, respectively.

9. The scanning probe microscope according to claim 1, further comprising a holder for the sensor that facilitates rapid probe exchange.

10. The scanning probe microscope according to claim 1 wherein the oscillator is operated at substantially its resonance frequency.

11. The scanning probe microscope according to claim 10 wherein the resonance frequency is greater than 400 kHz.

12. The scanning probe microscope according to claim 1 wherein the oscillator operates in a in a shear force mode by vibrating the probe approximately parallel to the surface of a sample.

13. The scanning probe microscope according to claim 1, further comprising a cantilever and wherein the probe is mounted to the cantilever and the cantilever is in turn mounted to the sensor to connect the probe to the sensor.

14. The scanning force microscope according to claim 1 wherein the means for scanning the probe with respect to the sample comprises a first electromechanical transducer and a second electromechanical transducer, the first electromechanical transducer having a first resonant frequency and the second electromechanical transducer having a second resonant frequency substantially lower than the first resonant frequency, and wherein the means responsive to the signal produced by the sensor electronics for moving the probe toward or away from the surface of the sample comprises a third electromechanical transducer having a third resonant frequency substantially higher than the first resonant frequency.

15. The scanning force microscope according to claim 14 wherein the first electromechanical transducer scans in an X direction and has a resonant frequency R(X), the second electromechanical transducer scans in a Y direction and has a resonant frequency R(Y), and the third electromechanical transducer scans in a Z direction and has a resonant frequency R(Z), and R(Z)>>R(X)>>R(Y).

16. The scanning force microscope according to claim 15 wherein the electromechanical transducers are piezoelectric ceramic actuators.

17. The scanning force microscope according to claim 15 wherein the first electromechanical transducer is a voice coil and the second and third electromechanical transducers are piezoelectric ceramic actuators.

18. The scanning probe microscope according to claim 1 wherein the means responsive to the signal produced by the sensor electronics for moving the probe toward or away from the surface of the sample comprises a first feedback loop for producing a first control signal, a first electromechanical transducer having a first resonant frequency, a second feedback loop for producing a second control signal, and a second electromechanical transducer having a second resonant frequency, the first resonant frequency being lower than the second resonant frequency.

19. The scanning probe microscope according to claim 18 wherein the first electromechanical transducer is employed to level the surface of the sample with respect to the sensor, whereby a range of motion imparted by the second electromechanical transducer to the probe is small.

20. The scanning probe microscope according to claim 14 wherein the motions imparted by the first and second electromechanical transducers to the probe are orthogonal to the motion imparted to the probe by the third electromechanical transducer, whereby a range of motion imparted by the third electromechanical transducer to the probe is small.

21. A scanning probe microscope for imaging the surface of a sample, comprising:
a sensor comprising an oscillator for producing a signal;
a probe connected to the sensor;
means for scanning the probe with respect to the sample comprising a first electromechanical transducer and a second electromechanical transducer, the first electromechanical transducer having a first resonant frequency and the second electromechanical transducer having a second resonant frequency substantially lower than the first resonant frequency;
sensor electronics connected to the sensor for monitoring the signal produced by the sensor; and
means responsive to the signal produced by the sensor electronics for moving the probe toward or away from the surface of the sample comprising a third electromechanical transducer having a third resonant frequency substantially higher than the first resonant frequency.

22. The scanning force microscope according to claim 21 wherein the first electromechanical transducer scans in an X direction and has a resonant frequency R(X), the second electromechanical transducer scans in a Y direction and has a resonant frequency R(Y), and the third electromechanical transducer scans in a Z direction and has a resonant frequency R(Z), and R(Z)>>R(X)>>R(Y).

23. The scanning force microscope according to claim 21 wherein the electromechanical transducers are piezoelectric ceramic actuators.

24. The scanning force microscope according to claim 21 wherein the first electromechanical transducer is a voice coil and the second and third electromechanical transducers are piezoelectric ceramic actuators.

25. The scanning probe microscope according to claim 21 wherein the motions imparted by the first and second electromechanical transducers to the probe are orthogonal to the motion imparted to the probe by the third electromechanical transducer, whereby a range of motion imparted by the third electromechanical transducer to the probe is small.

26. The scanning probe microscope according to claim 21, further comprising an optical microscope for viewing the location of the probe mounted to the sensor.

27. A method for operating a scanning probe microscope for initiating scanning the surface of a sample, comprising the steps of:
providing a sensor comprising an oscillator;
operating the oscillator over a range of frequencies;
determining the amplitude of current over the frequency range;
selecting a frequency from a current versus frequency curve;
using an optical microscope to position a probe connected to the oscillator with respect to a region of the sample surface to be scanned;
moving the probe toward the sample as the oscillator vibrates the probe;
detecting an acoustic frequency produced by the oscillator as the vibrating probe is moved to within approximately 100 nanometers of the sample;
detecting atomic force interaction when the probe is moved into proximity with the sample; and
scanning the sample after the probe is detected to be in proximity to the sample.

28. The method of claim 27 wherein the frequency at which the oscillator is operated is different from the frequency used for scanning.

29. The method of claim 27, further comprising the step of raising the probe so that the probe does not follow the surface on retrace during raster scanning.
